(19) United States
(12) Patent Application Publication
(10) Pub. No.: US 2008/0256184 A1
(43) Pub. Date: Oct. 16, 2008

(54) Systems and Methods of Contracting with Multiple Parties

(76) Inventors: Richard A. Ubaldi, Glenn Allen, VA (US); James E. Brown, Richmond, VA (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/867,833

(22) Filed: Oct. 5, 2007

Related U.S. Application Data
(60) Provisional application No. 60/849,637, filed on Oct. 5, 2006.

(51) Int. Cl. G06F 15/16

(52) U.S. Cl. 709/205

(57) ABSTRACT

Systems and methods for contracting with multiple parties, by which the multiple parties agree to a single contracting instrument, are presented. The systems generally comprise one or more computing devices connected to a data source, each of which are controlled by one or more entities interested in initiating a project. The data source has stored thereon a contracting instrument adapted for designating multiple parties. The systems also include a means for receiving the contracting instrument. The methods generally include the steps of identifying two or more contractors and identifying an owner interested in engaging the plurality of contractors to work on a project. After the contractors and owner have been identified, a single contracting instrument is prepared designating the contractors and the owner as executing parties to the single contracting instrument, which may then be executed.

### REFERENCE TO RELATED APPLICATIONS

This application claims priority to U.S. Provisional Application No. 60/849,637, filed on Oct. 5, 2006 and entitled “Method of Contracting with Multiple Parties”.

### TECHNICAL FIELD

This disclosure relates to contracting with multiple parties. More specifically, this disclosure relates to systems and methods for contracting with multiple parties, wherein the multiple parties agree to a single contracting instrument.

### BACKGROUND

The endeavour of initiating a new project, namely in the industrial and municipal sectors, is generally a process that requires a significant amount of preparation before work on the actual project can begin. Typically, a large part of project preparation involves an owner, the entity or entities heading the project, and one or more contractors to perform the actual work on the project. Typically, the project preparation culminates with a contractual agreement regarding, amongst other things, the terms and conditions relating to the work to be performed. However, most projects involve various areas of work, and with each requiring expertise in a specialized area. To address this issue, the owner hires multiple contractors, each requiring an individualized contractual agreement to define their scope of specialized work. Entering into multiple agreements requires additional and more diligent project management, and as a result, becomes increasingly impractical.

In an effort to avoid entering into multiple agreements, some owners enter into a single contract with a single prime contractor, supplier, or joint venture company. This prime contractor, supplier, or joint venture company then enters into subcontracts with other contractors, suppliers, or joint venture companies. The advantage to this approach is that the original contracting party, the owner, is only required to enter into a single agreement, thereby maintaining a single point of contact for any difficulties that may arise throughout the course of the project.

There are, however, significant disadvantages associated with this conventional approach. For one, prime contractors typically overcharge for subcontractor overhead, management, profit, risk, etc. To illustrate, a prime contractor typically enters into agreements with its subcontractors, whereby the subcontractors agree to charge the prime contractor a negotiated price for goods supplied and/or services rendered. The prime contractor then charges the owner an upcharge equal to the cost charged by subcontractor(s) plus an added 10-20%. In the case of multiple subcontractors, these upcharges could quickly become very expensive, leading to astronomical project costs.

Another disadvantage associated with this approach is a loss in direct control. The subcontractors contracted by the prime contractor are not under the control of the owner. Instead, they are bound by their agreement with the prime contractor. As a result, there can be no assurance that the terms and conditions intended by the owner will be incorporated into the subcontractor(s) agreements.

Other disadvantages associated with this approach may include an inability to effectively determine fault or liability, potential project delays, and gaps in performance and warranty coverage.

Accordingly, there is a need for providing an owner with greater control and flexibility at a substantially lower price when contracting with multiple parties.

### SUMMARY

We disclose a system for contracting with multiple parties. The system comprises one or more computing devices connected to a data source, each of which are controlled by one or more entities interested in initiating a project. The data source has stored thereon a contracting instrument adapted for designating multiple parties. The computing devices include a means for designating the one or more entities and two or more contractors as the multiple parties to the contracting instrument. Additionally, the system comprises a means for receiving the contracting instrument from the one or more computing devices for executing the contracting instrument.

We also disclose a system for contracting with multiple parties. The system comprises one or more computing devices connected to a data source, each of which are controlled by an owner interested in initiating a project. The data source has stored thereon a contracting instrument adapted for designating multiple parties. The computing devices include a means for designating the owner and two or more contractors as the multiple parties to the contracting instrument. Additionally, the system comprises a means for receiving the contracting instrument from the one or more computing devices for executing the contracting instrument.

We further disclose a method for contracting with multiple parties. The method includes the steps of identifying a plurality of prime contractors and identifying an owner interested in engaging the plurality of prime contractors to work on a project. After the contractors and owner have been identified, a single contracting instrument is prepared designating the contractors and the owner as executing parties to the single contracting instrument.

We still further disclose a method for contracting with multiple parties. The method includes the steps of designating one or more entities interested in initiating a project. Next, the one or more entities select two or more contractors to work on the project. Then a contracting instrument is prepared, listing the one or more entities and the two or more contractors as executing parties. Finally, the contracting instrument is executed by the executing parties.

### BRIEF DESCRIPTION OF THE DRAWINGS

FIG. 1 is a block diagram illustrating an exemplary contracting system.

FIG. 2 illustrates an exemplary contracting instrument.

FIG. 3 illustrates an exemplary work matrix.

FIG. 4 is a flow chart illustrating a method of contracting with multiple parties.

### DETAILED DESCRIPTION

Described herein are systems and methods for contracting with multiple parties, whereby multiple parties enter into a single contracting instrument to complete a project. To this end, an exemplary aspect relates to one or more entities desiring to initiate a project by entering into a single contractual agreement instrument with two or more contractors, whereby the one or more entities oversee the project, while the two or more contractors perform the work required to complete the project. An “entity”, as the term is used herein, should be broadly construed and describes a corporation, a company, a small business, a joint venture group, a contractor, or an individual as examples. A collection of one or more entities will hereinafter be described generally by the term ‘owner’.

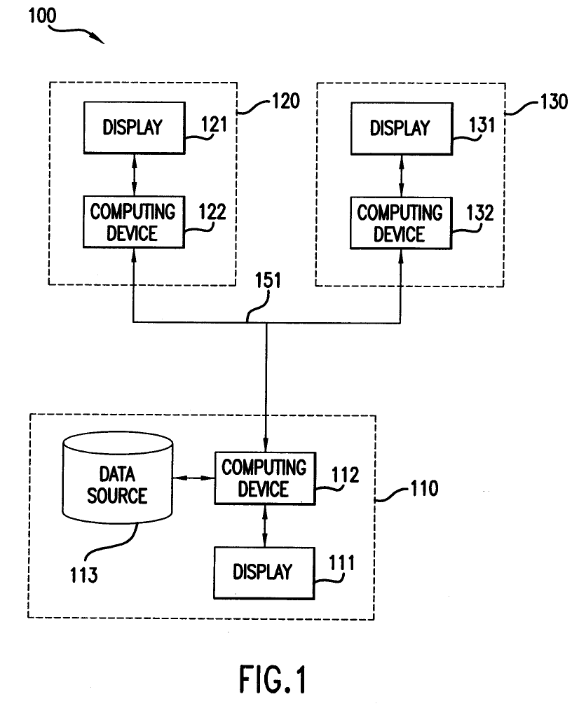

Referring now to FIG. 1, a contracting system 100 is shown. The contracting system 100 may include one or more communication systems 110 controlled by an owner interested in initiating a project, and two or more contractor communication systems 120 and 130. The system 100, while described below as having specific components, is certainly not limited thereto. Furthermore, the contracting system 100 may be customized for use in any desired industry desiring to contract multiple parties. For example, the contracting system 100 may be configured for use in the waste-water treatment industry, wherein the owner may be a waste-water management company interested in initiating a waste-water treatment project with multiple contractors.

Referring again to FIG. 1, the one or more owner-controlled communication system(s) 110 each preferably includes a computing device 112, a display device 111, and a data source 113. The computing device 112 preferably comprises a device capable of communicating with the data source 113 and preferably configured to store, run, and display one or more computer software programs that when run enable the computing device 112 to perform any number of desired tasks. To this end, the computing device 112 may comprise a personal computer, a laptop computer, a personal digital assistant (PDA) device, a mobile communication device, and the like.

Further, if configured to store and run software programs, the computing device 112 preferably comprises one or more software programs that may be utilized in facilitating a multi-party agreement such as, for example, a spreadsheet program, a word processing program, an internet browser, a document viewing program, and/or any other appropriate software program. Other computer software, such as an operating system and an email program, may be included in the computing device 112.

A display device 111 connects to the computing device 112. The display device 111 refers generally to any component that is connectable to the computing device 112 and capable of displaying documents, data, software program displays, and the like provided by the computing device 112. Example displays may include, for example, LCD screens, Plasma screens, CRT monitors, and the like. Preferably, the display device 111 may be directly integrated into the computing device 112, such as in a laptop computer to provide a single computing-display device.

Also connected to the computing device 112 is a data source 113. The data source 113 preferably comprises a database such as is found on a memory hard drive (internal or external), a floppy disk, a user input, or the like. Optionally, the data source 113 may be integrated into the computing device 112, thereby providing a single component for computing, displaying, and storing data. Further, integrating the data source 113 into the computing device 112 eliminates a need for an external connection between the computing device 112 and the data source 113.

Also included in the exemplary contracting system 100 are two or more contractor communication systems 120, 130, one each for each contractor desired to be made a party to a single contractual agreement. For example, if an owner desires to contract with three separate contractors, then the contracting system 100 preferably comprises three contractor communication systems, one each for the three contractors. However, there does not necessarily have to be a one-to-one correlation between the number of contractors and the number of contracting communication systems. A single contractor may utilize multiple contractor communication systems, and/or multiple contractors may utilize a single contractor communication system.

Each of the contractor communication systems 120, 130 preferably comprises a computing device 122, 132 and a display device 121, 131, either as separate components, or as single, integrated devices. Example integrated computing-display devices include, for example, laptop computers, PDAs, mobile communication devices, and the like.

Connecting the owner communication system 110 to the contractor communication systems 120, 130 is communication connection 151. This connection 151 may comprise a hard wired network, although a wireless network is preferred. Example communication connections include, but are not limited to, a dial-up modem connection, a Local Area Network (LAN), a Wide Area Network (WAN), cable modem, digital subscriber line (DSL), and the like. The connection 151 may comprise a wireless intranet or internet connection.

For purposes of illustration, the contracting system 100 will be described in the context of an industrial or municipal project requiring the work of at least two independent contractors, whereby an owner desires to bind the two or more contractors via a single contracting instrument. It should be understood, however, that the contracting system 100 is not limited to such an implementation but is instead adaptable for any implementation desiring to bind multiple parties via a single contracting instrument.

Thus, in the industrial or municipal project context, suppose an owner wishes to implement a project requiring the work of two or more contractors. The owner, via a computing device 112, may access and subsequently display a contracting instrument template stored on a data source 113. This contracting instrument template is adaptable for binding multiple parties. The owner can then modify, using the computing device 112, the contracting instrument template to reflect the terms and actual parties (i.e., the owner, and the two or more contractors) desired to be included in the single contracting instrument. Preferably, the data source 113 comprises lists or tables of potential contractual parties and/or potential contractual terms for inclusion in the contracting instrument. Alternatively, the owner may be the source of the contractual terms and parties.

The owner may use the computing device 112 to access the contracting instrument template stored on data source 113 and subsequently amend the template to include a formal statement designating the parties to the agreement. This formal statement of designation is preferably stored in the data source 113, although this statement may be provided from any source deemed appropriate by the owner. The following is an exemplary formal designation of an owner and two contractors:

“This CONTRACT is made and entered into as of the Dec. 31, 2006, by and between [OWNER], a corporation organized under the laws of the Commonwealth of Virginia with Offices located at YYY North Street, and [CONTRACTOR 1] a corporation organized under the laws of the Commonwealth of Virginia with Offices located at ZZZ West Street, and [CONTRACTOR 2] a corporation organized under the laws of the Commonwealth of Virginia with Offices located at QQQ South Street.”

Preferably, the computing device 112 is configured to automatically fill in the party designations (i.e., OWNER, CONTRACTOR 1, CONTRACTOR 2) upon the owner's selection of the same from a table stored in the data source 113. Alternatively, the owner may fill in the party designations using a computing device 112 input or using any other appropriate means, such as by manually writing in the designations once the contracting instrument has been transformed into a physical document (e.g., by printing the instrument via, for example, a laser jet printer).

Once the parties have been designated, the contracting instrument may be provided to the two or more contractor communication systems 120, 130 via the communication connection 151. The contracting instrument is preferably transmitted from the computing device 112 over the network 151 to the contractor communication systems 120, 130. The transmission of the contracting instrument may occur via email, for example, through the use of an email program stored on the computing device 112.

Once the contracting instrument is received by the computing devices 122, 132, it may be displayed on the display devices 121, 131. The contractors may then execute the contracting instrument using any appropriate means. If the contracting system 100 is so configured, the two or more contractors may electronically execute the contracting instrument using their respective communication systems 120, 130. Alternatively, the contractors may execute the contracting instrument by physically signing the instrument in sequence (i.e., one after the other). Once the two or more contractors have executed the contracting instrument, the owner may execute the same, thereby binding all three parties to a contractual agreement, under a single contracting instrument. It should be understood, however, that the order of execution is not paramount to contracting the multiple parties. Thus, the owner may be the first, the last, or any where in between, to execute the contracting instrument.

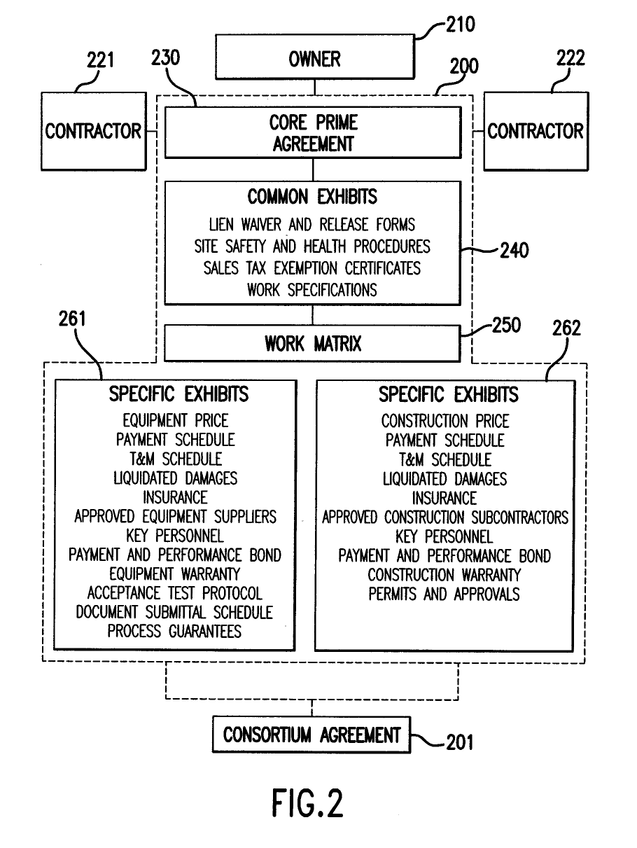

Referring now to FIG. 2, an exemplary contracting instrument 200 generated, for example, using a contracting system (e.g. contracting system 100 of FIG. 1) is shown. An owner 210 is shown as a designated executing party to the contracting instrument 200. As previously discussed, the term ‘owner’ refers to one or more entities desiring to initiate a project. In addition, two or more contractors 221, 222 are also shown as designated executing parties to the same contracting instrument 200.

As shown in FIG. 2, the exemplary contracting instrument 200 preferably comprises a core prime agreement 230, common exhibits 240, a scope of work matrix 250, and specific exhibits 261, 262 corresponding to each of the two or more contractors 221, 222, respectively.

The core prime agreement 230 preferably includes a table of contents listing the components of the contracting instrument 200. In this example, the core prime agreement 230 comprises the common exhibits 240, the scope of work matrix 250, and the specific exhibits 261 and 262. As such, the core prime agreement 230 and the multiple parties are designated under the contracting instrument 200. In addition, the core prime agreement 230 may be used to designate the multiple parties to the contracting instrument 200.

The contracting instrument 200 also comprises common exhibits 240. As the name implies, the common exhibits 240 comprise a plurality of terms which are common to the owner 210 and to the two or more contractors 221, 222, and to which each of the parties 210, 221, 222 agree. These common exhibits 240 preferably include general contractual terms and are not project or contractor specific. In the exemplary contracting instrument 200 of FIG. 2, the common exhibits 240 may include terms such as lien waiver and release forms, site safety and health procedures, sales tax exemption certificates, and work specifications, for example.

The exemplary contracting instrument 200 further comprises a list of tasks to be performed and a division of work approach designating particular tasks to the owner 210 and to the two or more contractors 221, 222 in the form of a work matrix 250. In use, the work matrix 250 effectively partitions the work needed to be performed. Each of the two or more contractors 221, 222 are assigned tasks based on their particular skill set and their ability to perform. Each task that must be performed to complete the project is listed on the work matrix 250. At least one party is designated to complete each and every task listed in the work matrix 250.

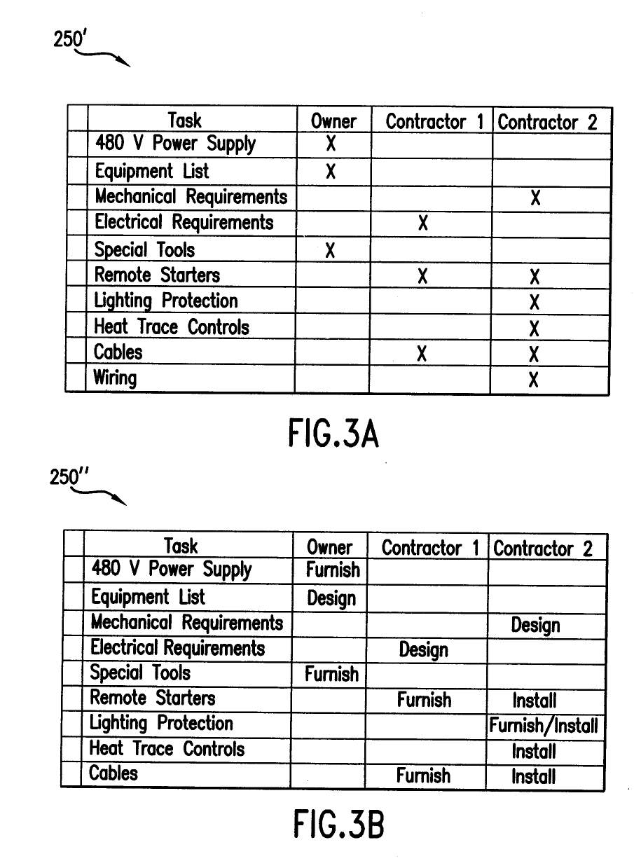

Referring briefly to FIGS. 3A and 3B, two exemplary work matrices 250′, 250″ are shown, respectively. Each work matrix 250′, 250″ comprises four columns. One column heading includes a list of tasks to be completed, and the remaining column headings include the designated parties, i.e., an owner and two or more contractors. In the “Task” column resides a list of all the tasks that must be completed to complete the project. Next to each task is shown the party(s) designated to complete that task. The party may be designated using any appropriate means, as illustrated in FIGS. 3A and 3B. In FIG. 3A, for example, a simple “x” is used to assign each task to a party. Alternatively, as shown in FIG. 3B, descriptive phases are used to assign tasks.

The descriptive phrases of FIG. 3B serve a dual purpose: 1) to designate the party(s) responsible for a particular task; and 2) to specify a general type of work that must be accomplished. For example, the 480 V Power supply is to be furnished by the owner, while the lighting protection is to be installed by the second contractor. In this example, ‘furnish’, ‘design’, and ‘install’ are used to provide a general description of the type of work required in each instance. Any appropriate phrases may be used in accordance with this example.

Aside from “x” and phrases, other forms of designation may be utilized. For example, a work matrix 250 may be designed to utilize software tools such as check boxes, radio buttons, or drop down lists, whereby the check boxes, radio buttons, or drop down lists may be used to designate the parties to the contracting instrument 200.

Referring again to FIG. 2, the contracting instrument 200 further comprises specific exhibits 261, 262. Each of the specific exhibits 261, 262 is associated with one of the two or more contractors 221, 222. In other words, for every contractor, there is an associated set of specific exhibits. These specific exhibits 261, 262 include contractual terms that are binding and specific to each respective contractor 221, 222. For example, the specific exhibits 261 associated with one contractor 221, are not binding on the other contractor 222, and vice versa. Exemplary terms that may be included in specific exhibits include equipment price, payment schedule, T&M schedule, liquidated damages, insurance, approved equipment suppliers, key personnel, payment and performance bond, equipment warranty, acceptance test protocol, document submittal schedule, process guarantees, construction price, approved construction subcontractors, construction warranty, and permits and approvals.

The contracting instrument 200 may optionally comprise a consortium agreement 201, by which the two or more contractors 221, 222 may separately agree to additional terms and conditions. The consortium agreement 201 is in essence a subcontract to the contracting instrument 200. Under the terms of such a consortium agreement 201, and subsequently, under the terms of the contracting instrument 200, the two or more contractors 221, 222 may agree to remain independent contractors, but to work together as required to perform their respective individual obligations under the contracting instrument 200. To this end, the contractors 221, 222 may execute their individual obligations as a single team, yet remain independent, unaffiliated contractors. Additionally, the consortium agreement 201 preferably protects the two or more contractors 221, 222 from another party's (e.g., another contractor) special, incidental, indirect, statutory, exemplary, punitive, or consequential damages. Additional terms that may be included in the consortium agreement 201 include terms directed toward safety procedures, complying with applicable laws, and other similar terms.

Notwithstanding this consortium agreement 201, unless specifically agreed upon in writing, neither of the contractors 221, 222 is authorized to make, or to hold itself out as having the authority to make, commitments, representations, warranties, or other agreements on behalf of the other.

Once the contracting instrument 200 has been appropriately completed to designate the owner 210 and the two or more contractors 221, 222, the contracting instrument 200 may be transmitted from an owner's communication system over the network to contractors' communication systems. The transmission of the contracting instrument 200 may be done by email, for example, through the use of the email program stored on the owner's computing device, by regular mail, by personal delivery, and the like.

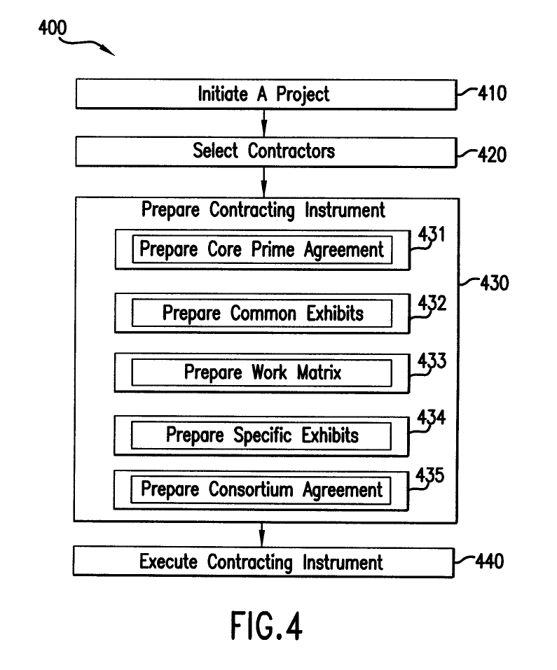

Referring now to FIG. 4, a flow diagram illustrating a method 400 for contracting with multiple parties using a single contracting instrument is shown. The first step in the contracting method 400 directs an owner to initiate a project (step 410). The owner, particularly in the industrial and municipal sectors, may include one or more entities interested in initiating such a project. Once the project is initiated (step 410), contractors are selected to perform specialized tasks in furtherance of the project (step 420). Conventional projects typically require two or more contractors, although any number of contractors may be selected.

After the owner has selected the contactors (step 420) to work on the project, in step 430, a single contracting instrument is prepared designating the owner and the contractors as executing parties to the contracting instrument (step 430). The preparation of the single contracting instrument (step 430) preferably includes the preparation of the various portions of the single contract, as will be discussed subsequently in steps 431-435.

In step 431, a core prime agreement is prepared. The core prime agreement preferably includes a table of contents, listing the components of the contracting instrument. In one example, the core prime agreement may comprise common exhibits, a scope of work matrix, and specific exhibits. The core prime agreement may also be used to designate the multiple parties to the contracting instrument.

Next, in step 432, the contracting instrument is preferably amended to include common exhibits to be agreed upon by the contractors and the owner. In an exemplary contracting instrument, the common exhibits may include lien waiver and release forms, site safety and health procedures, sales tax exemption certificates, and work specifications.

Next, in step 433, the contracting instrument is preferably amended to include a list of tasks to be performed and a division of work approach in the form of a work matrix. Each task that must be performed to complete the project is listed on the work matrix. At least one party (i.e., owner, contractors, etc.) is designated to complete each listed task in the work matrix.

The contracting instrument is then preferably amended to include specific exhibits to be agreed upon by the two or more contractors and the owner (step 434). Each of the specific exhibits is associated with one of the contractors. In other words, for every contractor, there is an associated set of specific exhibits. These specific exhibits include contractual terms that are binding and specific to the respective contractors. That is to say, the specific exhibits that bind one contractor do not necessarily bind any other contractor, and vice versa. In an exemplary contracting instrument, specific exhibits may include terms such as equipment price, payment schedule, T&M schedule, liquidated damages, insurance, approved equipment suppliers, key personnel, payment and performance bond, equipment warranty, acceptance test protocol, document submittal schedule, and process guarantees, approved construction subcontractors, construction warranty, permits and approvals, and the like.

Next, in step 435, an optional consortium agreement may be prepared. The consortium agreement is in essence a subcontract to the contracting instrument, whereby two or more contractors may separately agree to additional terms and conditions. Under the terms of such a consortium agreement, and subsequently under the terms of the contracting instrument, the contractors may agree to remain independent contractors but to work together as required to perform their respective individual obligations. Notwithstanding a consortium agreement, unless specifically agreed to in writing, neither of the contractors is authorized to make, or to hold itself out as having the authority to make, commitments, representations, warranties, or other agreements on behalf of the other. Generally, consortium agreements protect each of the parties thereto from liability as a result of damages attributable to another party, including special, incidental, indirect, statutory, exemplary, punitive, or consequential damages. Additional terms that may be part of a consortium agreement include employing proper safety procedures while working and complying with applicable laws.

Once, the contracting instrument is prepared (steps 431-435) and comprises the core prime agreement, the common exhibits, the work matrix, the specific exhibits, and possibly a consortium agreement, the contracting instrument may be executed (step 440) by the owner and the contractors. The contracting instrument may be executed by physically signing the contracting instrument, or by any other means previously described. Once the owner and the contractors have executed the contracting instrument (step 440), all executing parties will be bound to a contractual agreement, under a single contracting instrument.

A variety of modifications to the systems and methods described will be apparent to those skilled in the art from the disclosure provided herein. Thus, the systems and methods may be embodied in other specific forms without departing from the spirit or essential attributes thereof and, accordingly, reference should be made to the appended claims, rather than to the foregoing specification, as indicating the scope of this disclosure.

What is claimed:

1. A system for contracting with multiple parties comprising:
a data source controlled by one or more entities interested in initiating a project comprising a contracting instrument adapted for designating multiple parties;
one or more computing devices controlled by the one or more entities connected to the data source comprising means for designating the one or more entities and two or more contractors as the multiple parties to the contracting instrument; and
means for receiving the contracting instrument from the one or more computing devices for executing the contracting instrument.

2. The system of claim 1, wherein the means for receiving the contracting instrument comprises one or more computing devices controlled by the two or more contractors.

3. The system of claim 1, wherein the means for receiving the contracting instrument comprises at least one of a laptop computer, a mobile communication device, and a personal digital assistant (PDA).

4. The system of claim 1, wherein the contracting instrument comprises a core prime agreement.

5. The system of claim 1, wherein the contracting instrument comprises common exhibits.

6. The system of claim 1, wherein the contracting instrument comprises a list of tasks to be performed for completion of the project and a division of work approach designating at least one of the one or more entities and the two or more contractors to perform each of the tasks on the list of tasks, thereby forming a work matrix.

7. The system of claim 1, wherein the contracting instrument comprises specific exhibits.

8. The system of claim 1, wherein the contracting instrument comprises a consortium agreement between the two or more contractors to designate that each will work together with the one or more entities on the project.

9. A system for contracting with multiple parties comprising:
a data source controlled by an owner interested in initiating a project comprising a contracting instrument adapted for designating multiple parties;
one or more computing devices controlled by the owner connected to the data source comprising means for designating the owner and two or more contractors as the multiple parties to the contracting instrument; and
means for receiving the contracting instrument from the one or more computing devices for executing the contracting instrument.

10. The system of claim 9, wherein the means for receiving the contracting instrument comprises one or more computing devices controlled by the two or more contractors.

11. The system of claim 9, wherein the means for receiving the contracting instrument comprises at least one of a laptop computer, a mobile communication device, and a personal digital assistant (PDA).

12. The system of claim 9, wherein the contracting instrument comprises a core prime agreement.

13. The system of claim 9, wherein the contracting instrument comprises common exhibits.

14. The system of claim 9, wherein the contracting instrument comprises a list of tasks to be performed for completion of the project and a division of work approach designating at least one of the owner and the two or more contractors to perform each of the tasks on the list of tasks, thereby forming a work matrix.

15. The system of claim 9, wherein the contracting instrument comprises specific exhibits.

16. The system of claim 9, wherein the contracting instrument comprises a consortium agreement between the two or more contractors to designate that each will work together with the owner on the project.

17. A method of contracting with multiple parties comprising:
identifying a plurality of prime contractors;
identifying an owner interested in engaging the plurality of prime contractors; and
preparing a single contracting instrument designating the plurality of prime contractors and the owner as executing parties to the single contracting instrument.

18. The method of claim 17 further comprising:
preparing a core prime agreement.

19. The method of claim 17 further comprising:
preparing common exhibits.

20. The method of claim 17 further comprising:
preparing a list of tasks to be performed for completion of the project; and
preparing a division of work approach by designating the owner and the two or more contractors to perform each of the tasks on the list of tasks, thereby forming a work matrix.

21. The method of claim 17 further comprising:
preparing specific exhibits.

22. The method of claim 17 further comprising:
preparing a consortium agreement between the plurality of prime contractors to designate that each will work together with the owner on the project.

23. The method of claim 17 further comprising:
executing the contracting instrument by each of the owner and the plurality of contractors.

24. A method of contracting with multiple parties comprising:
designating one or more entities interested in initiating a project;
selecting two or more contractors to work on the project;
listing the one or more entities and the two or more contractors as parties to a single contracting instrument to complete the project; and
executing the contracting instrument by each of the one or more entities and the two or more contractors.

25. The method of claim 24 further comprising:
preparing a core prime agreement.

26. The method of claim 24 further comprising:
preparing common exhibits.

27. The method of claim 24 further comprising:
preparing a list of tasks to be performed for completion of the project; and
preparing a division of work approach by designating at least one of the one or more entities and the two or more contractors to perform each of the tasks on the list of tasks, thereby forming a work matrix.

28. The method of claim 24 further comprising:
preparing specific exhibits.

29. The method of claim 24 further comprising:
preparing a consortium agreement between the two or more contractors to designate that each will work together with the one or more entities on the project.
